(19) United States
(12) Patent Application Publication
(10) Pub. No.: US 2009/0323310 A1
(43) Pub. Date: Dec. 31, 2009

(54) Optical plate and backlight module using the same

(75) Inventor: Shao-Han Chang, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: Hon Hai Precision Industry Co., LTD

(21) Appl. No.: 12/319,043

(22) Filed: Dec. 31, 2008

(30) Foreign Application Priority Data
Jun. 30, 2008 (CN) 200810302423.3

(51) Int. Cl. F21V 3/02; B32B 3/30

(52) U.S. Cl. 362/97.1; 428/167

(57) ABSTRACT

An exemplary optical plate has a first surface and an opposite second surface. A plurality of elongated V-shaped protrusions and a plurality of elongated arc-shaped protrusions are arranged in an alternating manner. Each elongated V-shaped protrusion is substantially parallel to each arc-shaped protrusion. A plurality of elongated arc-shaped grooves is defined on the second surface. An extending direction of each elongated arc-shaped protrusion intersects with an extending direction of each elongated arc-shaped groove. A backlight module using the optical plate is also provided.

This application is related to two co-pending U.S. patent applications, applications serial no. [to be determined], with Attorney Docket No. US21577 and US21686, and all entitled “OPTICAL PLATE AND BACKLIGHT MODULE USING THE SAME”. The inventor of the co-pending applications is Shao-Han Chang. The co-pending applications have the same assignee as the present application.

### BACKGROUND OF THE INVENTION

1. Field of the Invention

The present invention relates to an optical plate and a backlight module using the same and, particularly, to an optical plate and a backlight module using the same employed in a liquid crystal display.

2. Description of the Related Art

Referring to FIGS. 10 and 11, a typical direct type backlight module 100 includes a frame 11, a plurality of light sources 12, a light diffusion plate 13, and a typical optical plate 10. The light sources 12 are positioned in an inner side of the frame 11. The light diffusion plate 13 and the typical optical plate 10 are positioned on the light sources 12 above a top of the frame 11. The light diffusion plate 13 includes a plurality of diffusing particles (not shown) to diffuse light. The typical optical plate 10 includes a transparent substrate 101 and a prism layer 103 formed on a surface of the transparent substrate 101. The prism layer 103 forms a plurality of elongated V-shaped protrusions 105.

Light from the light sources 12 enters the diffusion plate 13 and becomes scattered. The scattered light leaves the diffusion plate 13 to the prism sheet 10. The scattered light then travels through the typical optical plate 10 and is refracted out at the elongated V-shaped protrusions 105 of the typical optical plate 10. Thus, the refracted light leaving the typical optical plate 10 is concentrated at the prism layer 102 and increases the brightness (illumination) of the typical optical plate 10. The refracted light then propagates into a liquid crystal display panel (not shown) positioned above the typical optical plate 10.

However, light spot of the light sources 12 often occurs after light leaving the optical plate 10, even though light leaving the diffusion plate 13 becomes scattered. Referring to FIG. 12, if the diffusion plate 13 of the backlight module 100 is omitted, light emitted from the typical optical plate 10 will form two relatively strong light spots.

To reduce or eliminate the light spot of the light sources 12, the backlight module 100 may include an upper light diffusion film 14 positioned on the prism sheet 10. However, a plurality of air pockets exist at the boundary between the light diffusion film 14 and the prism sheet 10. When the liquid crystal display device 100 is in use, light passes through the air pockets, and some of the light undergoes total reflection at one or more boundaries. In addition, the upper light diffusion film 14 may absorb some of the light from the prism sheet 10. As a result, the light illumination brightness of the liquid crystal display device 100 is reduced.

Therefore, a new optical plate is desired in order to overcome the above-described shortcomings.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views, and all the views are schematic.

FIG. 1 is an isometric view of a first embodiment of an optical plate.

FIG. 2 is a cross-sectional view taken along the line II-II of FIG. 1.

FIG. 3 is a cross-sectional view taken along the line III-III of FIG. 1.

FIG. 4 is a photo showing an illumination distribution test result of an LED.

FIG. 5 is a photo showing an illumination distribution test result of the optical plate of FIG. 1 positioned above the LED.

FIG. 6 is a side cross-sectional view of a second embodiment of an optical plate.

FIG. 7 is a cross-sectional view of a third embodiment of an optical plate.

FIG. 8 is a plan view of a fourth embodiment of an optical plate

FIG. 9 is a cross-sectional view of the first embodiment of the optical plate in a backlight module.

FIG. 10 is a cross-sectional view of a typical backlight module.

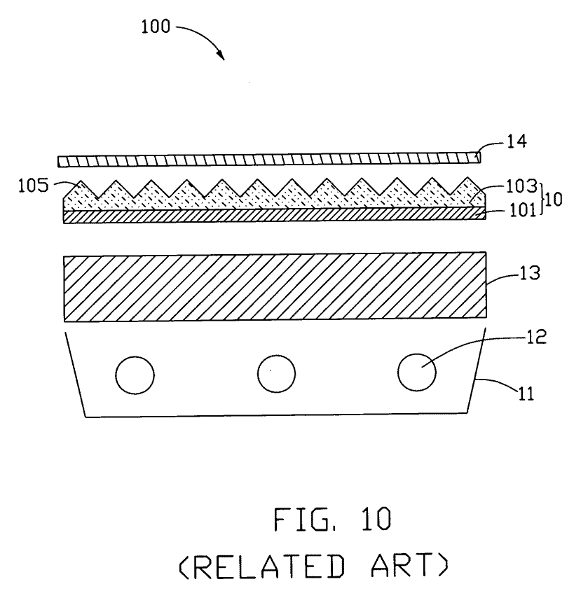

FIG. 11 is an isometric view of a typical optical plate in the typical backlight module of FIG. 10.

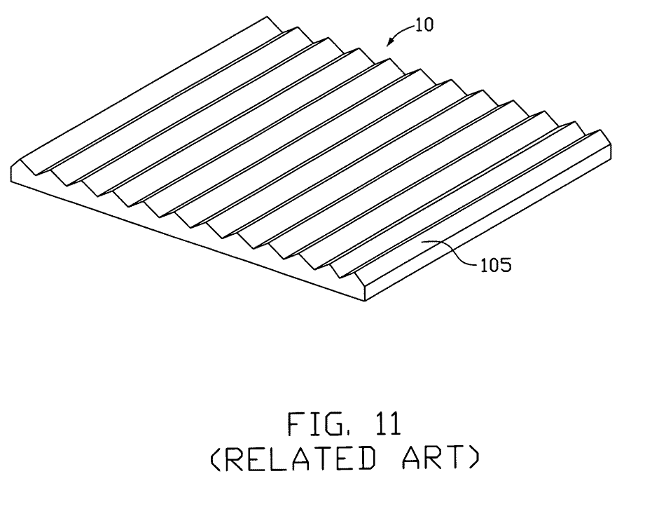

FIG. 12 is a photo showing an illumination distribution test result of the optical plate of FIG. 11 positioned above the LED.

### DETAILED DESCRIPTION OF THE PREFERRED EMBODIMENTS

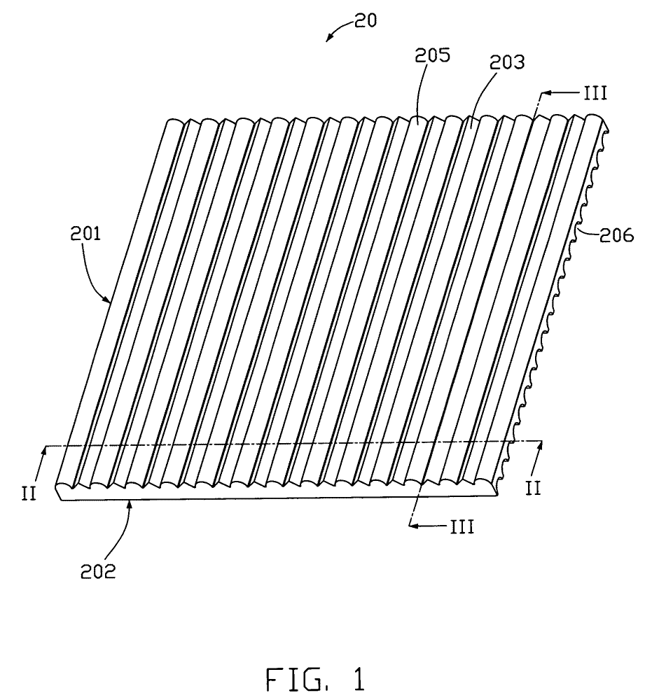

Referring to FIGS. 1 through 3, a first embodiment of an optical plate 20 includes a first surface 201 and a second surface 202 opposite the first surface 201. A plurality of elongated V-shaped protrusions 203 and a plurality of elongated arc-shaped protrusions 205 are formed on the first surface 201. The elongated V-shaped protrusions 203 and the elongated arc-shaped protrusions 205 are parallel to each other and arranged in an alternating manner. The second surface 202 defines a plurality of elongated arc-shaped grooves 206 distributed side by side. An extending direction of the elongated V-shaped protrusions 203 and the elongated arc-shaped protrusions 205 intersects with an extending direction of the elongated arc-shaped grooves 206. In the illustrated embodiment, the extending direction of the elongated arc-shaped protrusions 205 is substantially perpendicular to the extending direction of the elongated arc-shaped grooves 206. A cross-section of each elongated V-shaped protrusion 203 taken along a plane perpendicular to an extending direction of the elongated arc-shaped protrusion 205 may be substantially semicircular. A cross-section of each elongated arc-shaped groove 206 taken along a plane perpendicular to an extending direction of the elongated arc-shaped grooves 206 may be substantially semicircular.

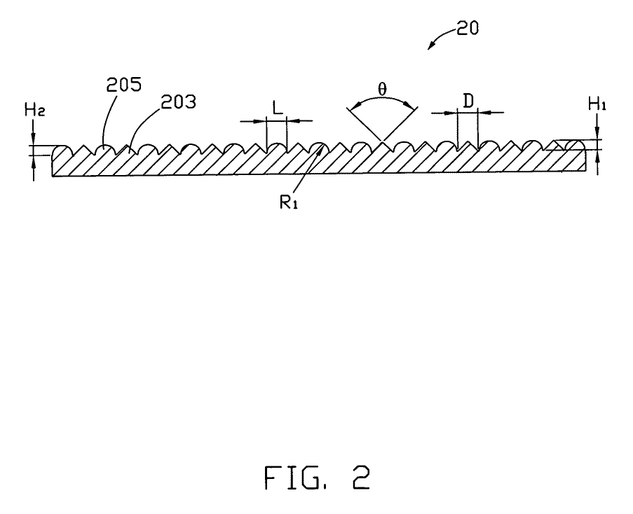

Referring to FIG. 2, a width D of each elongated V-shaped protrusions 203 is about 0.025 millimeters (mm) to about 1.5 mm. A height H₁ of each elongated arc-shaped protrusion 204 is about 0.01 mm to about 3 mm. A vertex angle of each elongated V-shaped protrusions 203 is about 80 degrees to about 100 degrees. A width L of each elongated arc-shaped protrusion 205 is about 0.025 millimeters to about 1.5 millimeters. A radius R₁ of each elongated arc-shaped protrusion 205 is about 0.01 mm to about 3 mm. A height H₂ of each elongated arc-shaped protrusion 205 is about 0.01 mm to about 3 mm.

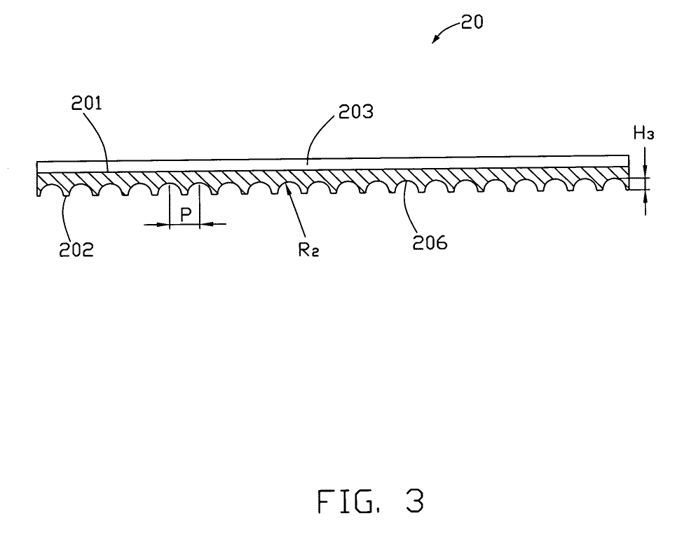

Referring to FIG. 3, a radius R₂ defined by each elongated arc-shaped groove 206 is about 0.01 mm to about 3 mm. A pitch P between adjacent elongated arc-shaped grooves 202, measured between corresponding points on the cross-section lines, is about 0.025 mm to about 1.5 mm. A depth H₃ of each elongated arc-shaped groove 202 is about 0.01 mm to about 3 mm.

A thickness of the optical plate 20 is about 0.5 mm to about 3 mm. The optical plate 20 may be made of a material such as polycarbonate, polymethyl methacrylate, polystyrene, and copolymer of methyl methacrylate and styrene.

The optical plate 20 may be integrally formed by an injection mold including a first mold piece and a second mold piece. The first mold piece includes a plurality of elongated V-shaped grooves and a plurality of elongated arc-shaped grooves formed on a surface. The second mold piece includes a plurality of elongated arc-shaped protrusions formed on a surface. The elongated V-shaped grooves are configured to form the elongated V-shaped protrusions 203 on the first surface 201 of the optical plate 20, the elongated arc-shaped grooves are configured to form the elongated arc-shaped protrusions 205, and the elongated arc-shaped protrusions are configured to form the elongated arc-shaped grooves 206. Therefore, both sides of the optical plate can be produced at a same time for each injection molding process.

Since the elongated V-shaped protrusions 203 and the elongated arc-shaped protrusions 205 are integrally formed by the injection mold, the optical plate 20 has a better rigidity and mechanical strength than the typical optical plate. Thus, the optical plate 20 has a relatively high reliability.

Referring to Table 1 below, test samples show an optical performance of the optical plate 20 in contrast to that of the typical optical plate 10.

TABLE 1

| Test samples | Condition |
|---|---|
| 1 | LED |
| 2 | LED + typical optical plate 10 |
| 3 | LED + optical plate 20 |

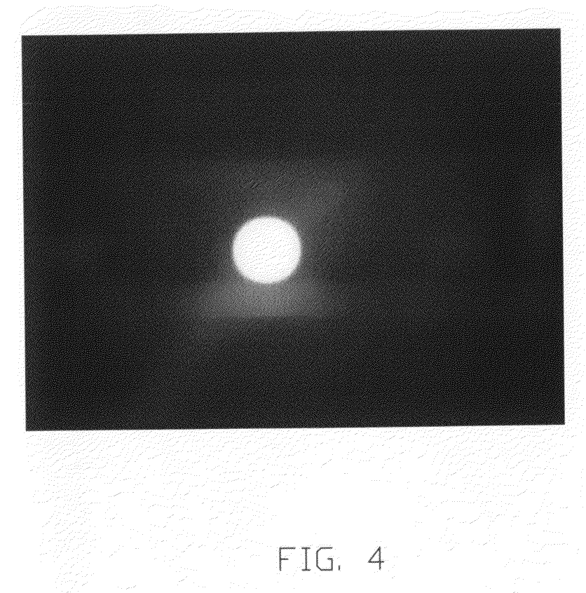

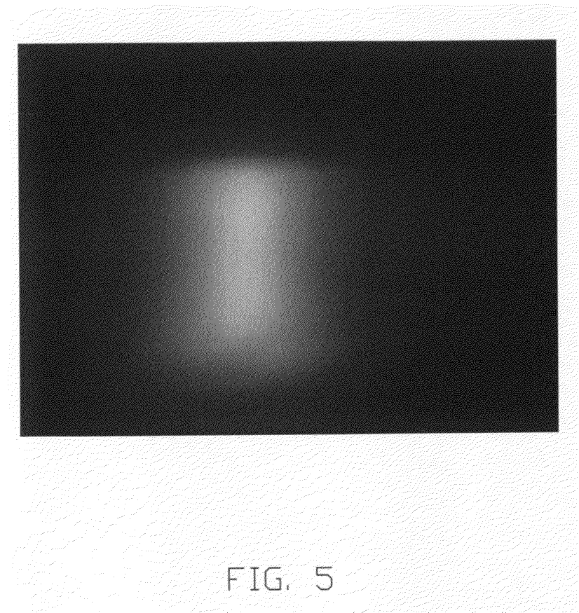

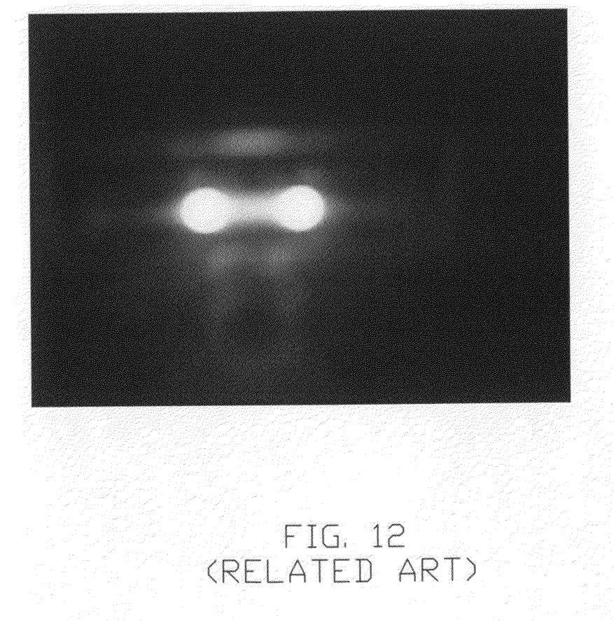

Referring to FIGS. 4, 5 and 12, which reflect the test results from the test conditions in Table 1. Light emitted from the typical optical plate 10 will form two relatively strong light spots as shown in FIG. 12. Light emitted from the optical plate 20 will form a substantially rectangular light region as shown in FIG. 5. The test results show light emitted from the optical plate 20 can transform a spot light, such as light from an LED, to a more uniform surface light source.

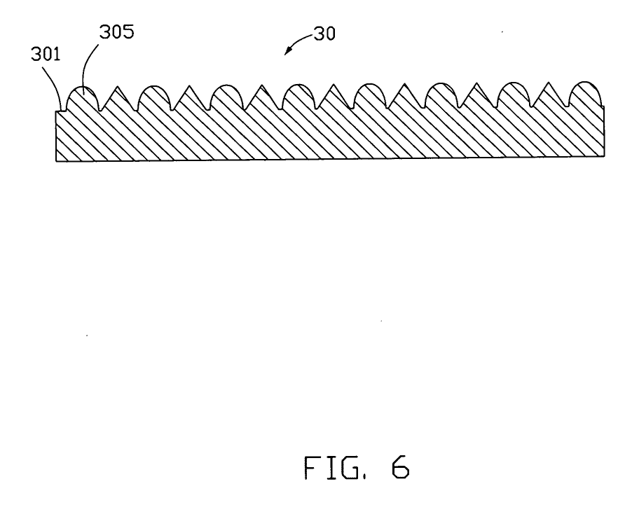

Referring to FIG. 6, a second embodiment of an optical plate 30 is similar in principle to the first embodiment of the optical plate 20, except that a plurality of elongated arc-shaped protrusions 305 formed on a first surface 301 is different from the arc-shaped protrusions 205 of the optical plate 20. A cross-section of each elongated arc-shaped protrusions 305 taken along a plane perpendicular to an extending direction of the elongated arc-shaped protrusions 305 is substantially semi-elliptical.

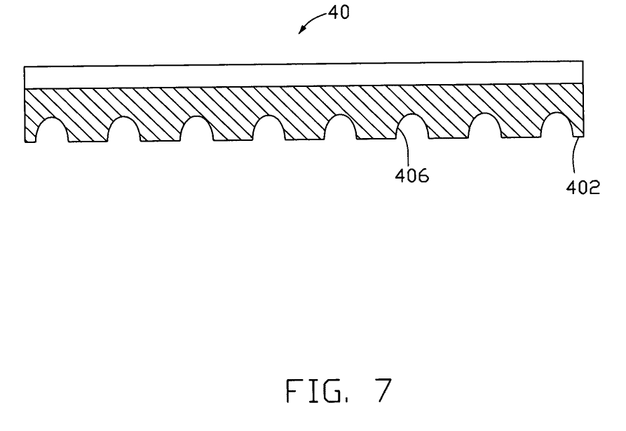

Referring to FIG. 7, a third embodiment of an optical plate 40 is similar in principle to the first embodiment of the optical plate 20, except that a plurality of elongated arc-shaped grooves 406 formed on a second surface 402 is different from the arc-shaped grooves 206 of the optical plate 20. A cross-section of each elongated arc-shaped grooves 406 taken along a plane perpendicular to an extending direction of the elongated arc-shaped grooves 406 is substantially semi-elliptical.

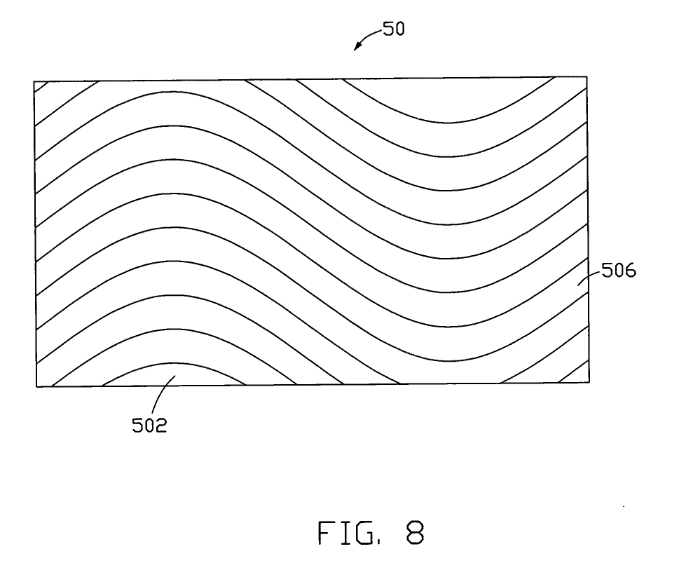

Referring to FIG. 8, a fourth embodiment of an optical plate 50 is similar in principle to the first embodiment of the optical plate 20, except that a plurality of elongated arc-shaped grooves 506 formed on a second surface 502 of the optical plate 50 extend along a plurality of parallel predetermined curve lines.

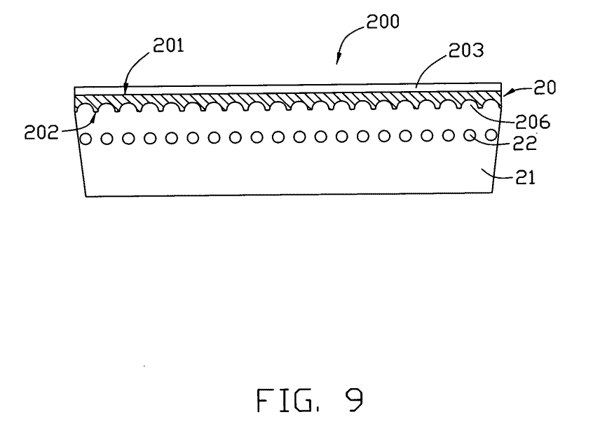

Referring to FIGS. 1 and 9, a backlight module 200 includes a first embodiment of an optical plate 20, a frame 21, and a plurality of linear light sources 22. The linear light sources 22 are positioned in an inner side of the frame 21. In the illustrated embodiment, the linear light sources 22 are cold cathode tubes. The optical plate 20 is positioned on the light sources 22 above a top of the frame 21. The frame 21 may be made of metal or plastic materials, and has high reflectivity inner surfaces. In the illustrated embodiment, the second surface 202 is opposite to the linear light sources 22, and the extending direction of each elongated arc-shaped groove 206 in the second surface 202 is parallel to an extending direction of each linear light source 22.

Light emitted from the linear light sources 22 first enters the optical plate 20 via the second surface 202. Since the inner surfaces of the elongated arc-shaped grooves 206 of the second surface 202 are curved, and the elongated V-shaped protrusions 203 and the elongated V-shaped protrusions 203 are arranged in an alternating manner on the first surface 201, incident light that may have been internally reflected on a flat surface, are refracted, reflected, and diffracted. As a result, light outputted from the first surface 201 is more uniform than light outputted from a light output surface of a typical optical plate and light spots caused by the light sources seldom occur. In addition, an extra upper light diffusion film between the optical plate 20 and the liquid crystal display panel is unnecessary. Thus, the efficiency of light utilization is enhanced.

It may be appreciated that when a distance between the linear light sources 22 is too long, a diffusion plate can be employed in the backlight module 200 between the optical plate 20 and the linear light sources 22, to improve the optical uniformity of the backlight module 200. In addition, the linear light sources 22 may be replaced by a plurality of point light sources such as light-emitting diodes, distributed in rows.

It is believed that the present embodiments and their advantages will be understood from the foregoing description, and it will be apparent that various changes may be made thereto without departing from the spirit and scope of the present disclosure or sacrificing all of its material advantages, the examples hereinbefore described merely being preferred or exemplary embodiments.

What is claimed is:

1. An optical plate having a first surface and an opposite second surface, wherein a plurality of elongated V-shaped protrusions and a plurality of elongated arc-shaped protrusions are arranged in an alternating manner on the first surface, and a plurality of elongated arc-shaped grooves is defined in the second surface, each elongated V-shaped protrusion is substantially parallel to each arc-shaped protrusion, an extending direction of each elongated V-shaped protrusion and each elongated arc-shaped protrusion intersects with an extending direction of each elongated arc-shaped groove.

2. The optical plate as claimed in claim 1, wherein the extending direction of each elongated V-shaped protrusion and each elongated arc-shaped protrusion is substantially perpendicular to the extending direction of each elongated arc-shaped groove.

3. The optical plate as claimed in claim 1, wherein the elongated arc-shaped grooves extend along a plurality of parallel curved lines.

4. The optical plate as claimed in claim 1, wherein the elongated arc-shaped grooves are distributed side by side.

5. The optical plate as claimed in claim 1, wherein a cross-section of each elongated arc-shaped groove taken along a plane perpendicular to the extending direction of the elongated arc-shaped grooves is substantially semicircular or semi-elliptical.

6. The optical plate as claimed in claim 1, wherein a radius defined by each elongated arc-shaped groove is about 0.01 millimeters to about 3 millimeters.

7. The optical plate as claimed in claim 1, wherein a depth of each elongated arc-shaped groove is about 0.01 millimeters to about 3 millimeters.

8. The optical plate as claimed in claim 1, wherein a thickness of the optical plate is about 0.5 millimeters to about 3 millimeters.

9. The optical plate as claimed in claim 1, wherein a cross-section of each elongated arc-shaped protrusion taken along a plane perpendicular to the extending direction of the elongated arc-shaped protrusions is substantially semicircular or semi-elliptical.

10. The optical plate as claimed in claim 1, wherein a radius of each elongated arc-shaped protrusion is about 0.01 millimeters to about 3 millimeters.

11. The optical plate as claimed in claim 1, wherein a height of each elongated arc-shaped protrusion is about 0.01 millimeters to about 3 millimeters.

12. The optical plate as claimed in claim 1, wherein a vertex angle of each elongated V-shaped protrusion is about 80 degrees to 100 degrees.

13. The optical plate as claimed in claim 1, wherein a width of each elongated V-shaped protrusion is about 0.025 millimeters to about 1.5 millimeters.

14. The optical plate as claimed in claim 1, wherein a material of the optical plate is selected from the group consisting of polycarbonate, polymethyl methacrylate, polystyrene, and copolymer of methylmethacrylate and styrene.

15. A backlight module comprising:
a frame;
a plurality of light sources positioned in an inner surface of the frame; and
an optical plate positioned on the light diffusion plate, the optical plate having a first surface and an opposite second surface, wherein a plurality of elongated arc-shaped grooves is defined in the first surface, and a plurality of elongated V-shaped protrusions and a plurality of elongated arc-shaped protrusions are arranged in an alternating manner on the second surface, each elongated V-shaped protrusion is substantially parallel to each arc-shaped protrusion, an extending direction of each elongated V-shaped protrusion and each elongated arc-shaped protrusion intersects with an extending direction of each elongated arc-shaped groove.

16. The backlight module as claimed in claim 15, further comprising a light diffusion plate positioned on the frame between the light sources and the optical plate.

17. The backlight module as claimed in claim 15, wherein the extending direction of each elongated V-shaped protrusion and each elongated arc-shaped protrusion is substantially perpendicular to the extending direction of each elongated arc-shaped groove.

18. The backlight module as claimed in claim 15, wherein the second surface is opposite the light sources.

19. The backlight module as claimed in claim 15, wherein the light sources are linear light sources.

20. The backlight module as claimed in claim 19, wherein the extending direction of the elongated arc-shaped protrusions are substantially parallel to a longitudinal direction of the light sources.
